(19) United States
(12) Patent Application Publication
(10) Pub. No.: US 2021/0354807 A1
(43) Pub. Date: Nov. 18, 2021

(54) AUTONOMOUS VEHICLE BATTERY CARRIER TO SUPPORT ELECTRIC AIRCRAFT TAXIING AND TAKEOFF

(71) Applicant: Robert Blackmore Collins, Valla Beach New South Wales (AU)

(72) Inventor: Robert Blackmore Collins, Valla Beach New South Wales (AU)

(21) Appl. No.: 15/930,510

(22) Filed: May 13, 2020

(51) Int. Cl. B64C 25/40; B64D 41/00; B64D 15/12; B60L 7/10; G05D 1/02; B60L 9/00; B60L 53/14

(52) U.S. Cl. CPC B64C 25/405; B64D 41/00; B64D 15/12; B64D 2221/00; G05D 1/0212; B60L 9/00; B60L 53/14; B60L 7/10

(57) ABSTRACT

A ground power system for supplying electrical power to an aircraft and method of using the same is disclosed in which an electric motor is connected to an aircraft wheel to drive the aircraft wheel, an autonomous vehicle battery carrier is releasably connected to the aircraft through an articulating robotic arm to power the electric motor and to move the aircraft on the ground to support aircraft taxiing and preparation for takeoff using the battery power from the autonomous vehicle, and a command system releases the autonomous vehicle battery carrier as roll begins but before the aircraft rotates.

### BACKGROUND

The present invention relates to autonomous electric power assistance for aircraft taxiing, takeoff, and other services.

An airplane's jet engines are highly inefficient for moving the aircraft on the ground at low speeds. In particular, jet engines are noisy, unsafe for ground staff, ingest foreign objects, can consume 10-15% of fuel at major hub airports, and are incapable of reversing. Despite their many disadvantages, however, jet engines remain the primary mode of aircraft ground movement.

To increase aircraft ground travel efficiency, various electric motorized wheel assemblies have been introduced. These electric motors, however, typically require either the use of an on-board APU (auxiliary power unit), or use of the main engine to convert fuel to mechanical power and then electricity or to charge batteries on board the aircraft. Either solution uses jet fuel, either directly as a fuel source or by adding to overall weight thereby requiring the use of additional fuel.

Furthermore, as another power requirement, de-icing of aircraft (i.e., the removal of ice from aircraft aerodynamic surfaces) is currently carried out by high pressure spraying of heated glycol solutions onto aircraft at special de-icing stations on the way to the runway. This method is energy intensive, time consuming, costly, and environmentally problematic. Alternatively, newer carbon fiber based aircraft, such as the Boeing® Dreamliner, use fine electric wires embedded directly in the aircraft carbon fiber to heat the surfaces. These fine electric wires, however, require a large amount of power to maintain sufficient heat at the aircraft surface to prevent the formation of ice on the aircraft.

Therefore, a need exists for a lightweight high-performance assembly, which may be used with current aircraft, to assist jets in taxiing and takeoff at major airports to provide greater flexibility for aircraft range and payload weight, noise reduction, power to aircraft de-icing processes, and significant reductions in jet fuel usage.

### SUMMARY

In one aspect, the invention is a ground power unit for supplying electrical power to an aircraft. The ground power system includes an aircraft wheel on an aircraft, an electric (e.g., induction) motor connected to the aircraft wheel to drive the aircraft wheel, an autonomous vehicle battery carrier releasably connected to the aircraft through an articulating robotic arm to power the electric motor and to move the aircraft on the ground to support aircraft taxiing and preparation for takeoff using the battery power from the autonomous vehicle. A command system releases the autonomous vehicle battery carrier as roll begins but before the aircraft rotates.

In another aspect, the invention is a ground power unit for driving an aircraft wheel on the ground. The ground power unit includes an aircraft wheel on an aircraft and a motor assembly in the hub of the aircraft wheel for driving the aircraft wheel; the wheel and motor assembly are configured to fit substantially completely within existing wheel well space of the aircraft and with the remainder of the landing gear in the aircraft. The ground power unit further includes an autonomous vehicle battery carrier connected to the power supply of the aircraft via an articulating robotic arm capable of automated connection and disconnection to and from the aircraft. The ground power unit contains sufficient power to drive the wheel and thereby drive the aircraft during ground movement of the aircraft.

In another aspect, the invention is an electric power connector assembly designed to provide a supply of electric power from a source of electric power located externally to an aircraft to an electric drive means mounted to power an aircraft landing gear drive wheel to move the aircraft autonomously on the ground. The connector assembly includes a power distribution assembly in electrical connection with an electric drive means mounted to power an aircraft landing gear drive wheel and drive the aircraft autonomously on the ground, an electric connector element in electric connection between the power distribution assembly, and a source of electric power external to the aircraft. The source of electric power is housed in an autonomous vehicle capable of automatically following the aircraft.

In another aspect, the invention is a method of aircraft ground travel using electric power instead of the aircraft's flight engines. In this aspect, the invention includes the steps of connecting a battery housed in an autonomous vehicle battery carrier by an automated articulating robotic arm to a motor assembly on a wheel of the aircraft for driving the aircraft wheel and thereby driving the aircraft on the ground after the aircraft has landed on the runway and before takeoff.

In another aspect, the invention is a method of aircraft ground travel using electric power instead of the aircraft's flight engines. In this aspect, the invention includes the steps of connecting an autonomous vehicle battery carrier by an automated articulating robotic arm to a motor assembly on a wheel of an aircraft, powering the motor assembly with the autonomous vehicle battery carrier during taxiing and rollout to drive the aircraft wheel without drawing on-board power from the aircraft, and disconnecting the motor assembly from the autonomous vehicle battery carrier by disconnecting the automatic articulating robotic arm before wheel rotation and takeoff.

Although this invention will be described hereinafter with particular reference to the accompanying drawings, in which an illustrative embodiment of the present invention is set forth, it is to be understood at the outset of the description which follows that it is contemplated that persons skilled in the applicable art may modify the specific details to be described while continuing to use this invention. Accordingly, the description is to be understood as a broad teaching of this invention, directed to persons skilled in the applicable arts.

### BRIEF DESCRIPTION OF THE DRAWINGS

FIG. 1 is a perspective view of the autonomous vehicle battery carrier.

FIG. 2 is a perspective view of the electric connector.

FIG. 3 is a perspective view of an aircraft and autonomous vehicle battery carrier.

FIG. 4 is a partially exploded perspective of the aircraft landing gear with electric motor and perspective view of the autonomous vehicle battery carrier.

FIG. 5 is a perspective view of the interior of an aircraft cockpit.

### DETAILED DESCRIPTION

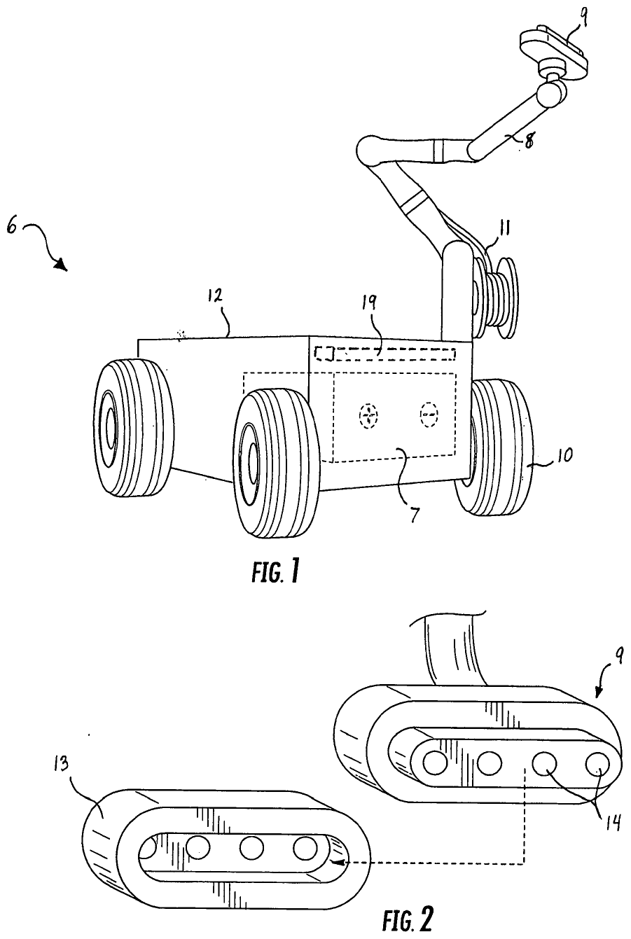

As shown in FIGS. 1-5, the invention is the combination of an aircraft wheel 21 on an aircraft 15, an electric (e.g., induction) motor 25 connected to the aircraft wheel 21 to drive the aircraft wheel 21, an autonomous vehicle battery carrier 6 releasably connected to the aircraft 15 through an articulating robotic arm 8 to power the electric motor 25 and to move the aircraft 15 on the ground to support aircraft 15 taxiing and takeoff using the power from the battery 7 within the autonomous vehicle battery carrier 6, and a command system 19 that releases the autonomous vehicle battery carrier 6 as the aircraft 15 reaches a speed of 120 mph, but before the aircraft 15 rotates at a speed of 150 mph.

Referring to FIG. 4, the wheel 21 and motor assembly 28 is configured to fit substantially completely within the well space of an existing wheel 21 in conventional aircraft 15 landing gear 16, 17, and 18. The autonomous vehicle battery carrier 6 is capable of automatically following the aircraft 15.

As shown in FIG. 1, the articulating robotic arm 8 includes a connector 9 (e.g., plug or equivalent) that can be automatically connected and disconnected to a connector recipient portion 13 on the aircraft 15 based on relevant factors such as the aircraft's 15 location. The battery 7 (or batteries) provides sufficient power to the motor 25 during taxiing and takeoff to maneuver the wheels 21 of the landing gear 16, 17, 18 during aircraft 15 ground movement without the need for any on-board power from the aircraft 15.

In an exemplary embodiment, the autonomous vehicle battery carrier 6 has wheels 10 so it may easily maneuver to the best position to trail the aircraft 15. The vehicle body of the autonomous vehicle battery carrier 6 itself can also take many forms, so long as some portion is capable of housing the battery 7 (or batteries) (e.g., a simple battery housing unit 12 as shown in FIG. 1), and an on-board command system 19.

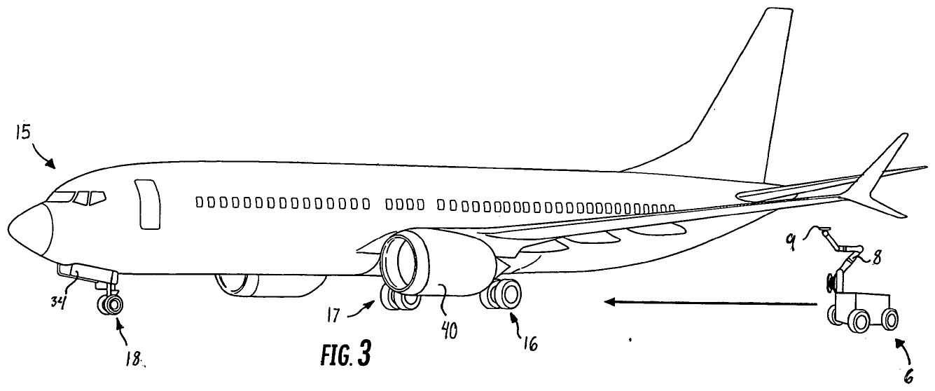

As depicted in FIG. 1 and more closely in FIG. 2, the connector 9 may take the form of a magnetic plug 14 so as to ensure quick and easy release. The figures depict the male end of the connector 9 on the terminal end of the articulating robotic arm 8 and the female end of the connector 13 on the aircraft 15, but any configuration that would permit the transfer of power from the battery 7 to the electric motor 25 (or motors) may be implemented.

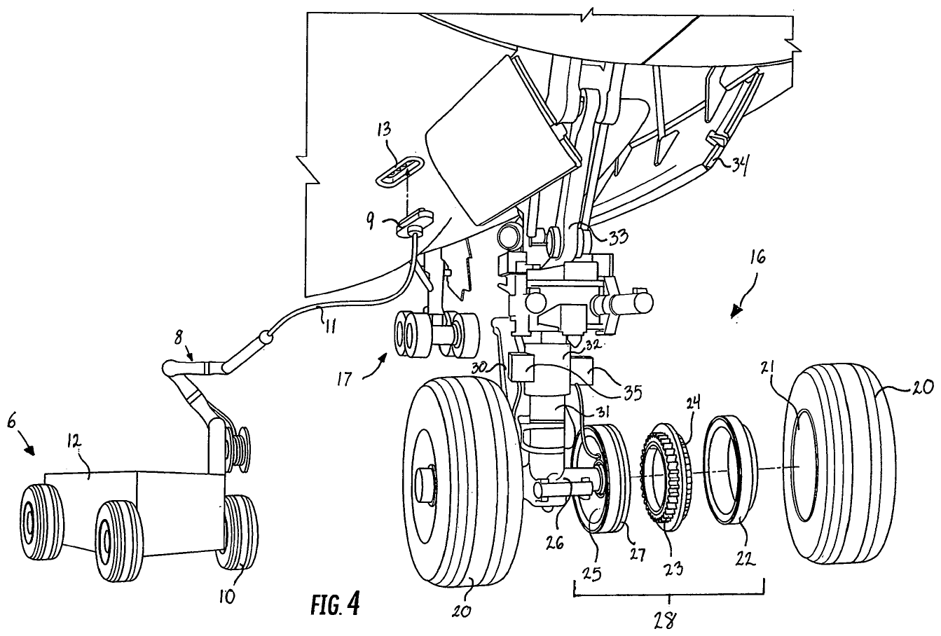

FIG. 3 further illustrates a method of aircraft ground travel using electric power instead of the aircraft's 15 flight engines. In the aircraft 15 landing aspect, the invention includes the steps of connecting a battery 7 housed in an autonomous vehicle battery carrier 6 by automated articulating robotic arm 8 to a motor assembly 28 for driving an aircraft wheel 21 on the ground after the aircraft 15 has landed on the runway.

In a complementary series of steps, the autonomous vehicle battery carrier 6 powers the motor 25 of the motor assembly 28 during taxiing and rollout to maneuver the wheels 21 of the aircraft landing gear motor assembly 28 by disconnecting the automatic articulating robotic arm 8 before wheel 21 rotation and takeoff.

As seen in FIG. 4, The wheel 21, motor 25, and autonomous vehicle battery carrier 6 assembly can be retrofitted in an existing aircraft wheel 21 without changing existing landing gear 16, 17, 18 components, including tires 20, piston 31, and axle 26. The retrofitted aircraft wheels 21 would thus be able to fit within the existing aircraft 15 without the need to change aircraft 15 interior spacing or the landing gear doors 34.

In an exemplary embodiment, the power electronics 29 are located in the motor assembly 28 retrofitted in an existing aircraft wheel 21. The power electronics 29 would be housed in conjunction with the electric motor 25, a capacitor ring 27, stator 23, bearing 24, rotor 22, and brake assembly 30.

Alternatively, the power electronics 29 may be located in separate power housing units 35 on the piston cylinder 32 of the aircraft landing gear 16, 17, 18, but in a manner so as not to obstruct the downlock and drag brace 33 of the existing aircraft 15 landing gear 16, 17, 18.

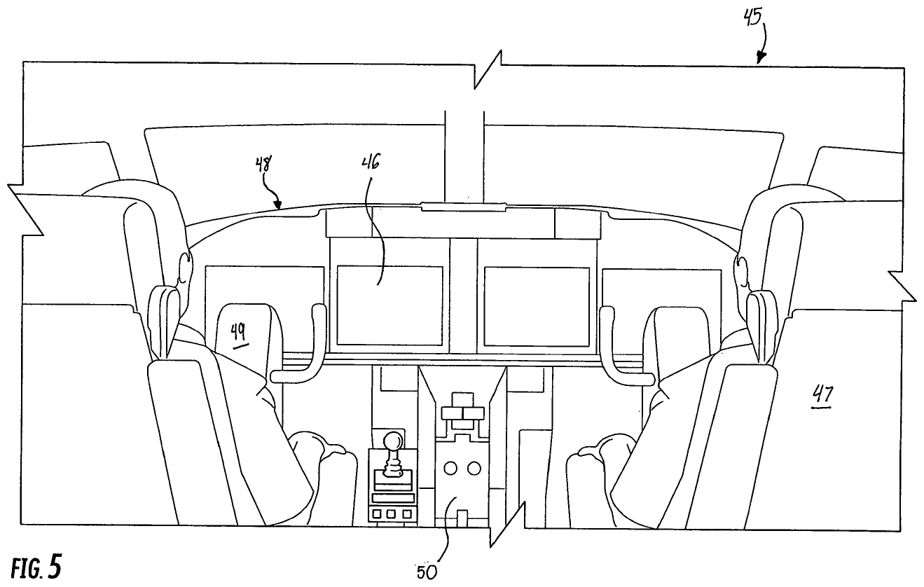

As shown in FIG. 5, The wheel 21, motor 25, and autonomous vehicle battery carrier 6 assembly described herein further comprises a cockpit interface 46 to activate the motor 25 assembly and gear system 23 means when activation of the motor 25 assembly means and the gear system 23 means is indicated to be safe. Thus, aircraft 15 personnel can control the connection and release of the autonomous vehicle battery carrier 6 from the control cabin 45 without the need for on-the-ground air traffic controllers.

In an exemplary embodiment, the cockpit interface 46 is located in the instrument panel 48 with the other various flight displays, but the cockpit interface 46 may also be located in the pedestal 50 depending on the aircraft layout, just so long as the cockpit interface 46 is visible to the pilots while they are seated in their seats 47 in the cockpit and handling the yoke 49.

The autonomous vehicle battery carrier 6 can follow the aircraft's 15 main landing gear 16, 17, 18 wheels 21 at a distance sufficiently far to avoid interference or collision with aircraft wheels 21 or landing gear 16, 17, 18, but sufficiently close to charge the motor assembly 28.

The motor assembly 28 can include a lightweight high-performance electric motor 25 that attaches to an aircraft's 15 main landing wheels 21 to power the wheels 21 during taxiing and takeoff without the need for jet fuel.

The articulating robotic arm 8 connects to a quick connect/disconnect connector 13 (e.g., plug) on the bottom of the aircraft 15 fuselage behind the main landing gear 16, 17, which plugs and unplugs the autonomous vehicle battery carrier 6 power cable 11 that charges the electric motor 25. The connector 9 automatically disconnects towards the end of the aircraft 15 takeoff run, before the aircraft 15 rotates or becomes airborne. The autonomous vehicle battery carrier 6 can wait on the taxiway at the end of the runway after supporting a takeoff, or can move to any other defined or desired position, and can pick up the next aircraft 15 after it lands and as it turns to taxi to the terminal. The articulating robotic arm 8 is better for these purposes than (for example) flexible cables, which lack the capability to articulate to the aircraft 15 (e.g., after landing).

Each motor 25 has (for example) between about 50 and 500 kW capacity (e.g. 275 kW capacity) and is placed at each wheel 21 to produce a 20-30% boost to acceleration during takeoff. Because aircraft 15 wheel 21 count is directly correlated to airplane size, the invention is scalable to various commercial aircraft (e.g., the Boeing 737 has 4 wheels 21 and would require a total motor 25 capacity of 1100 kW, whereas the Boeing 747 has 16 wheels 21 and would require a total motor 25 capacity of 4400 kW).

The battery 7 within the autonomous vehicle battery carrier 6 provides power to the motor assembly 28 as the aircraft 15 taxies to the terminal, unloads and loads for the next flight, taxies to the runway and performs takeoff. The autonomous vehicle battery carrier 6 recharges its battery 7 (or batteries) while supporting the aircraft 15 at the terminal.

The motor assembly 28 described herein adds substantially less to the weight of an aircraft 15 than previously proposed motor and power supply assemblies because the battery 7, power electronics 29, command system 19, and much of the cabling 11 are maintained within the autonomous vehicle battery carrier 6 external to the aircraft 15.

In the preferred embodiment, the motor assembly 28 described herein adds approximately one third of the weight to an aircraft 15 as previously-proposed motor and power supply assemblies.

As an added “green” advantage, the batteries 7 can be recharged from a variety of sources, including (for example) renewable resources such as solar panels at the airports or on the autonomous vehicle battery carrier 6.

The invention has the potential to increase overall fuel efficiency by 10-20%, improve range and payload from existing airports, and reduce ground handling costs. The invention will also reduce airport noise during taxing and takeoff and allow for downwind takeoffs to avoid suburban fly-overs due to increased speed on existing runways. The invention will also increase safety for ground staff and reduce the risk of foreign object ingestion because jet engines 40 may be either completely or mostly powered off during much of the aircraft's 15 ground travel.

The electric motor 25 can be used for regenerative braking during landing, reducing the need for large mass of carbon disc brakes in the hub portion of the aircraft 15 wheel 21. The weight and volume of the electric motor 25 in each wheel 21 is similar to the weight and volume of carbon disc brakes in conventional aircraft 15 wheels 21. The invention's regenerative braking will greatly reduce the wear and maintenance of brake assemblies 30.

During regenerative braking, electric motors 25 generate up to 400 kW of electricity for 10-20 seconds, which may be absorbed by ultra-capacitors on each landing gear bogie (i.e., attaching mechanism between the landing gear strut and wheels). Ultra-capacitors are fairly similar to batteries for energy storage, but they can accept much greater loads instantaneously, and which they are only able to store for shorter periods of time because they store energy by electrostatics rather than chemically. Ultra-capacitors are currently used in electric cars with batteries for regenerative braking and peak acceleration. This energy can be stored at landing and made available to the aircraft 15 for several hours after takeoff. In the invention, the autonomous vehicle will disconnect during takeoff when the aircraft reaches approximately 120 mph. The aircraft 15 will still have approximately another ten seconds on the ground as it accelerates up to a rotation speed of approximately 150 mph. The recovered energy during regenerative braking can be stored in a battery or ultra-capacitor on board the aircraft 15 and during takeoff. This recovered energy would be particularly useful to the aircraft 15 in the period after the autonomous battery carrier 6 had disconnected from the aircraft 15 and before aircraft 15 rotation on takeoff.

Lightweight high power rare earth electric motors have a weight and volume similar to the large carbon disc brakes used in conventional aircraft wheel hubs, and also with similar kinetic energy requirements for takeoff and landing (approximately 900 kW for each wheel of a Boeing 737). Normally, on landing the aircraft 15 brake assemblies 30 absorb approximately ¼ of the as heat in the carbon discs. The remainder of the energy is absorbed by reverse thrusters, aerodynamic drag, and rolling drag on a long runway. One major disadvantage of this traditional assembly is that aircraft 15 brakes can become heavily worn and ultimately destroyed, particularly during aircraft 15 takeoff at maximum speed with limited runway, wherein the carbon discs can heat up to 1200° C. High power electric motors, however, are able to handle all normal braking requirements during landing using regenerative braking, leaving carbon brakes free to be used only for parking the aircraft 15 and to assist regenerative braking during rejected takeoffs, thereby extending their lifespan.

Furthermore, fixed length runways require that aircraft maximum weight be limited by the speed it can accelerate to cover a given fixed distance. Often, this means that payload or fuel has to be offloaded to deal with higher altitude runways with lower air density, no wind to takeoff into, or long duration flights. The invention, however, increases aircraft acceleration and velocity over a runway fixed distance by up to 40%. Alternatively, the invention can allow the aircraft turbofan engines to run at lower thrust levels to reduce noise for night takeoffs. The invention thus provides much greater flexibility for aircraft weight limits, take off locations and times of day (due to noise reductions), and fuel savings.

Because regenerative braking causes no wear to the brakes and reduces the instances in which carbon brakes are used, carbon brakes can be greatly reduced in size. The high power electric motor 25 and smaller carbon brakes should thus fit into the existing wheels 21. Accordingly, the inventions newer brake assembly 30 should last nearly the lifetime of the aircraft 15, rather than needing to be changed every 300 landings, as currently done. Moreover, the electric motors 25 on the wheels 21 can spin the wheels 21 up to landing speed prior to landing the aircraft 15. Several studies have indicated this could reduce tire 20 changes by up to 99%. Instead of changing tires 20 every sixty landings as at present, aircraft 15 could perform thousands of landings before tires 20 need to be changed. The combination of wheel 21 spin up before landing and regenerative braking will also provide much better control of the aircraft 15 in wet conditions or cross wind landings, in addition to the significant reductions in maintenance.

The large multi megawatt power capability the autonomous vehicle battery carrier 6 can supply to an aircraft 15 would make electric heat anti-icing possible during winter for aircraft 15 prior to takeoff. In newer aircraft 15 with carbon fiber aerodynamic surfaces, electrical wires may also be embedded directly in the carbon fiber aerodynamic surfaces to provide icing prevention, so long as a suitably large power source is available to heat the electrical wires to a temperature sufficient to de-ice the aircraft 15. This could eliminate many costs and environmental problems associated with current de-icing techniques.

Furthermore, unlike other inventions in this technical field, the invention allows the pilot to maintain complete control of the aircraft on the ground, rather than coordinating with tug drivers for aircraft movement at airport gates.

In the drawings and specification there has been set forth a preferred embodiment of the invention, and although specific terms have been employed, they are used in a generic and descriptive sense only and not for purposes of limitation, the scope of the invention being defined in the claims.

1. A ground power system for supplying electrical power to an aircraft on the ground, the ground power system comprising:
an aircraft wheel on an aircraft;
an electric motor connected to said aircraft wheel to drive said aircraft wheel;
an autonomous vehicle battery carrier releasably connected to said aircraft through an articulating robotic arm to power said electric motor and to move said aircraft on the ground to support aircraft taxiing and preparation for takeoff using the battery power from said autonomous vehicle; and
a command system that releases said autonomous vehicle battery carrier during takeoff but before said aircraft rotates.

2. A ground power system according to claim 1 wherein said electric motor is configured to fit substantially in an existing aircraft wheel without changing existing landing gear components, including tires, piston, and axle.

3. A ground power system according to claim 1 further comprising a cockpit interface for activating said electric motor when activation of said electric motor is indicated to be safe.

4. A ground power system according to claim 1 wherein said autonomous vehicle battery carrier further comprises:
environmental sensors to perceive vehicle surroundings;
advanced control systems to interpret sensory information from said sensors and identify aircraft locations and appropriate navigation paths; and
said advanced control systems being programmed to direct said autonomous vehicle battery carrier to follow said aircraft's main landing gear wheels at a distance sufficiently far to avoid interference or collision with said aircraft's wheels or landing gear, but sufficiently close to charge said electric motor.

5. A ground power system according to claim 1 wherein said articulating robotic arm connects to a magnetic plug on the bottom of the aircraft fuselage behind the main landing gear.

6. A ground power system according to claim 1 wherein said motor is between 50 and 500 kW capacity.

7. A ground power system according to claim 1 wherein said electric motor is an induction motor.

8. A ground power system according to claim 1 wherein said battery provides sufficient power to electrically heat wires on said aircraft for anti-icing said aircraft.

9. A ground power system for driving an aircraft wheel on the ground comprising:
an aircraft wheel on an aircraft and a motor assembly in the hub of said aircraft wheel for driving said aircraft wheel;
said wheel and motor assembly being configured to fit substantially completely within existing wheel well space of said aircraft and with the remainder of the landing gear in said aircraft;
an autonomous vehicle battery carrier connected to the power supply of said aircraft via an articulating robotic arm capable of automated connection and disconnection to and from said aircraft; and
said autonomous vehicle battery carrier having sufficient power to drive said wheel and thereby drive said aircraft during ground movement of said aircraft.

10. A ground power system according to claim 9 wherein said motor assembly is configured to fit substantially in an existing aircraft wheel without changing existing landing gear components, including tires, piston, and axle.

11. A ground power system according to claim 9 further comprising a cockpit interface for activating said motor assembly when activation of said motor assembly is indicated to be safe.

12. A ground power system according to claim 9 wherein said autonomous vehicle battery carrier further comprises:
environmental sensors to perceive vehicle surroundings;
advanced control systems to interpret the sensory information from said sensors and identify aircraft locations and appropriate navigation paths; and
said advanced control systems being programmed to direct said autonomous vehicle battery carrier to follow said aircraft's main landing gear wheels at a distance sufficiently far to avoid interference or collision with said aircraft's wheels or landing gear, but sufficiently close to charge said electric motor.

13. A ground power system according to claim 9 wherein said articulating robotic arm connects to a magnetic plug on the bottom of the aircraft fuselage behind the main landing gear.

14. An electric power connector assembly designed to provide a supply of electric power from a source of electric power located externally of an aircraft to an electric drive means mounted to power an aircraft landing gear drive wheel to move the aircraft on the ground, comprising:
a power distribution assembly in electrical connection with an electric drive means mounted to power an aircraft landing gear drive wheel and drive said aircraft on the ground;
an electric connector element in electric connection between said power distribution assembly and a source of electric power external to said aircraft, wherein said source of electric power is housed in an autonomous vehicle capable of automatically following said aircraft.

15. A method of aircraft ground travel using electric power instead of the aircraft's flight engines comprising:
connecting a battery housed in an autonomous vehicle battery carrier by an automated articulating robotic arm to a motor assembly on a wheel of the aircraft for driving the aircraft wheel and thereby driving the aircraft on the ground after the aircraft has landed on the runway and before takeoff.

16. A method of aircraft ground travel according to claim 15 further comprising disconnecting the battery from the motor assembly via the automatic articulating robotic arm before rotation and takeoff.

17. A method of aircraft ground travel according to claim 15 further comprising directing the autonomous vehicle battery carrier to trail the aircraft on the ground.

18. A method of aircraft ground travel using electric power instead of the aircraft's flight engines comprising:
connecting an autonomous vehicle battery carrier by an automated articulating robotic arm to a motor assembly on a wheel of an aircraft;
powering the motor assembly with the autonomous vehicle battery carrier during taxiing and takeoff to drive the aircraft wheel without drawing on-board power from the aircraft, and
disconnecting the motor assembly from the autonomous vehicle battery carrier by disconnecting the automatic articulating robotic arm before rotation and takeoff.

19. A method of aircraft ground travel according to claim 18 further comprising directing the autonomous vehicle battery carrier to trail the aircraft on the ground.

20. A method of aircraft ground travel according to claim 18 wherein the motor assembly provides regenerative braking during aircraft landing sufficient to meet normal braking requirements.
